(19) United States
(12) Patent Application Publication
(10) Pub. No.: US 2010/0271191 A1
(43) Pub. Date: Oct. 28, 2010

(54) SYSTEMS, DEVICES, AND METHODS UTILIZING STRETCHABLE ELECTRONICS TO MEASURE TIRE OR ROAD SURFACE CONDITIONS

(76) Inventors: Bassel de Graff, San Juan (TT); Gilman Calsen, Malden, MA (US); William J. Arora, Boston, MA (US); Eugene Kuznetsov, Cambridge, MA (US); Roozbeh Ghaffari, Cambridge, MA (US)

Correspondence Address: GTC Law Group LLP & Affiliates, P.O. Box 113237, Pittsburgh, PA, 15241, US

(21) Appl. No.: 12/625,444

(22) Filed: Nov. 24, 2009

Related U.S. Application Data
(63) Continuation-in-part of application No. 12/616,922, filed on Nov. 12, 2009.
Application No. 12/616,922 is a continuation-in-part of application No. 12/575,008, filed on Oct. 7, 2009.
(60) Provisional application No. 61/117,235, filed on Nov. 24, 2008.
(60) Provisional application No. 61/120,904, filed on Dec. 9, 2008.
(60) Provisional application No. 61/113,622, filed on Nov. 12, 2008.
(60) Provisional application No. 61/103,361, filed on Oct. 7, 2008.
(60) Provisional application No. 61/113,007, filed on Nov. 10, 2008.

(51) Int. Cl. B60C 23/00; G01M 17/02

(52) U.S. Cl. 340/447; 73/146

(57) ABSTRACT

In embodiments, the present invention may comprise a sensor-based tire data collection facility integrated with the body of a vehicle tire, wherein the sensor-based tire data collection facility includes a stretchable electronics circuit and a wireless communications facility for communicating data collected by the sensor-based tire data collection facility to a vehicle data collection facility external to the body of the vehicle tire.

### CROSS-REFERENCE TO RELATED APPLICATIONS

This application claims the benefit of U.S. Provisional Application No. 61/117,235 entitled “Road Feel Apparatus for Measuring Tire and/or Surface Conditions” filed on Nov. 24, 2008, the entirety of which is incorporated herein by reference. This application also claims the benefit of U.S. Provisional Application No. 61/120,904 entitled “Transfer Printing” filed Dec. 9, 2008, the entirety of which is incorporated herein by reference. This application is also a continuation-in-part of U.S. Nonprovisional application Ser. No. 12/616,922 entitled “Extremely Stretchable Electronics” filed Nov. 12, 2009, the entirety of which is incorporated herein by reference. U.S. Nonprovisional application Ser. No. 12/616,922 claims the benefit of U.S. Provisional Application No. 61/113,622 entitled “Extremely Stretchable Interconnects” filed Nov. 12, 2008, the entirety of which is incorporated herein by reference. U.S. Nonprovisional application Ser. No. 12/616,922 is a continuation-in-part of U.S. patent application Ser. No. 12/575,008 entitled “Catheter Balloon Having Stretchable Integrated Circuitry and Sensor Array” filed Oct. 7, 2009. U.S. Nonprovisional patent application Ser. No. 12/575,008 claims the benefit of U.S. Provisional Application No. 61/103,361 entitled “Catheter Balloon Sensor and Imaging Arrays” filed on Oct. 7, 2008 and also claims the benefit of U.S. Provisional Application No. 61/113,007 entitled “Catheter Balloon with Sensor and Imaging Array” filed Nov. 10, 2008.

### FIELD OF THE INVENTION

The present invention relates to systems, apparatuses, and methods utilizing expandable or stretchable integrated circuitry, and more particularly to extremely stretchable circuitry integrated with a vehicle tire.

### BACKGROUND OF THE INVENTION

Advanced traction and stability control systems have become standard features in luxury cars. These systems monitor individual wheel speed, car position, and other variables, and dynamically adjust power output, power distribution, or braking pressure on individual wheels. In-the-tire pressure sensors are able to provide temperature and pressure displays to the driver for safety and handling reasons. Systems have been created both to harvest the mechanical energy of the tire to provide power to such sensors and to transmit the collected information wirelessly to the car's computer. The effectiveness of these systems is limited by the paucity of knowledge about road surface available to the control system due to the challenges of implementing sensor-based monitoring on or in the tire, given the dynamically deforming surfaces of the tire. Therefore a need exists for tire-embedded electronic monitoring systems capable of operating in the dynamically deforming structure of an operational tire.

### SUMMARY OF THE INVENTION

Embodiments of the present invention include a tire lined with flexible and/or stretchable circuits to create a comprehensive sensor system for monitoring road and tire features related to vehicle handling. The features include areas of contact between the tire and driving surface, strain, and shearing forces in the tire, the nature of the road surface, and the like. Such a sensor can be used in automotive design applications, bicycles, motorcycles, aircraft landing gear, integrated in luxury cars, and the like.

In embodiments, the benefits of this invention in passenger automobiles are derived from obtaining real-time information about the road-tire interface. In addition to providing additional information on traction and stability, the control systems also can optimize performance and/or safety. Furthermore, the sensor can optionally provide a real-time display, such as of the contact patch of each tire to the driver using existing in-dash display. In addition to its entertainment value, such a display can help drivers understand road conditions, improve their driving, optimize their tire pressure or type of tires, and the like. The benefits of the invention for automotive engineering include improved mechanisms for testing suspension systems, drive trains, tire designs in real road conditions, and the like. The benefits in the field of aircraft landing gear include both design-time and operational monitoring of landing gear stresses and braking performance. Conditions of landing gear tires during takeoff and landing have been implicated in a number of aircraft mishaps. Additional information about the state of tires and the tire-runway interface can also enhance pilot decision making and/or aircraft management systems. Benefits to high-end bicycles or motorcycles can include improving competitive athletic performance and two wheeled vehicle handling.

These and other systems, methods, objects, features, and advantages of the present invention will be apparent to those skilled in the art from the following detailed description of the preferred embodiment and the drawings.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 depicts a buckled interconnection.

FIG. 2 depicts a stretchable electronics configuration with semiconductor islands mounted on an elastomeric substrate with stretchable interconnects.

FIG. 3 depicts an extremely stretchable interconnect.

FIG. 4 depicts a raised stretchable interconnect with expandable elastomeric substrate.

FIG. 5 depicts a method for controlled adhesion on an elastomeric stamp.

FIGS. 6A and 6B depict an embodiment of the present invention showing a stretchable electronics integrated into a road tire.

FIG. 7 depicts a circuit for implementing collection of data and communication of the data to a data collection facility in an embodiment of the present invention.

FIG. 8 depicts an automotive embodiment of the present invention, showing how data could be communicated to a data collection facility.

FIG. 9 depicts a graphic user interface in an automotive embodiment of the present invention.

FIG. 10 depicts a block diagram in an embodiment of the present invention, where a sensor-based tire data collection facility is integrated with the body of a vehicle tire.

FIG. 11 depicts a block diagram in an embodiment of the present invention, where a plurality of functional electronic devices is arrayed on the surface of the tire and physically integrated.

FIG. 12 depicts a block diagram in an embodiment of the present invention, where a device communicates wirelessly from a tire.

### DETAILED DESCRIPTION OF THE INVENTION

The present invention may employ one or more of a plurality of flexible and/or stretchable electronics technologies in the implementation thereof. Traditionally, electronics have been fabricated on rigid structures, such as on integrated circuits, hybrid integrated circuits, and on printed circuit boards. Integrated circuits, also referred to as ICs, microcircuits, microchips, silicon chips, or simple chips, have been traditionally fabricated on a thin substrate of semiconductor material, and have been constrained to rigid substrates mainly due to the high temperatures required in the step of inorganic semiconductor deposition. Hybrid integrated circuits and printed circuit boards have been the main method for integrating multiple ICs together, such as through mounting the ICs onto a ceramic, epoxy resin, or other rigid non-conducting surface. These interconnecting surfaces have traditionally been rigid in order to ensure that the electrical interconnection methods, such as solder joints to the board and metal traces across the boards, do not break or fracture when flexed. In addition, the ICs themselves may fracture if flexed. And so in the past, the field of electronics has been largely constrained to rigid electronics structures, which then tend to constrain electronics applications that may require flexibility.

However, in recent years flexible and bendable electronics technologies have emerged that enable flexible electronics applications, such as with organic and inorganic semiconductors on flexible plastic substrates, and other technologies described herein. Further, stretchable electronics technologies have emerged that enable applications that require the electronics to be stretchable, such as through the use of mounting ICs on flexible substrates and interconnected through some method of stretchable electrical interconnect, and other technologies as described herein. The present invention may utilize one or more of these flexible, bendable, stretchable, and like technologies, in applications that require the electronics to operate in configurations that may not be, or remain, rigid and planar, such as applications that require electronics to flex, bend, expand, stretch and the like.

The present invention utilizes flexible, bendable, stretchable, and the like technologies for circuitry such as those described below. In embodiments, the circuitry of the invention may be made in part or in full by utilizing the techniques and processes described below. Note that the below description of the various ways to achieve stretchable and/or flexible electronics is not meant to be limiting, and encompasses suitable variants and or modifications within the ambient of one skilled in the art. As such, this application will refer to the following U.S. Patents and Patent Applications, each of which is incorporated by reference herein in its entirety: U.S. Pat. No. 7,557,367 entitled “Stretchable Semiconductor Elements and Stretchable Electrical Circuits”, issued Jul. 7, 2009 (the “'367 patent”); U.S. Pat. No. 7,521,292 entitled “Stretchable Form of Single Crystal Silicon for High Performance Electronics on Rubber Substrates”, issued Apr. 29, 2009 (the “'292 patent”); United States Published Patent Application No. 20080157235 entitled “Controlled Buckling Structures in Semiconductor Interconnects and Nanomembranes for Stretchable Electronics”, filed Sep. 6, 2007 (the “'235 application”); U.S. patent application having Ser. No. 12/398,811 entitled “Stretchable and Foldable Electronics”, filed Mar. 5, 2009 (the “'811 application”); United States Published Patent Application No. 20040192082 entitled “Stretchable and Elastic Interconnects” filed Mar. 28, 2003 (the “'082 application”); United States Published Patent Application No. 20070134849 entitled “Method For Embedding Dies”, filed Nov. 21, 2006 (the “'849 application”); United States Published Patent Application No. 20080064125 entitled “Extendable Connector and Network, filed Sep. 12, 2007 (the “'125 application”); U.S. Provisional Patent Application having Ser. No. 61/240,262 (the “'262 application”) “Stretchable Electronics”, filed Sep. 7, 2009; U.S. patent application having Ser. No. 12/616,922 entitled “Extremely Stretchable Electronics”, filed Nov. 12, 2009 (the “'922 application”); U.S. Provisional Patent Application having Ser. No. 61/120,904 entitled “Transfer Printing”, filed Dec. 9, 2008 (the “'904 application”); United States Published Patent Application No. 20060286488 entitled “Methods and Devices for Fabricating Three-Dimensional Nanoscale Structures”, filed Dec. 1, 2004; U.S. Pat. No. 7,195,733 entitled “Composite Patterning Devices for Soft Lithography” issued Mar. 27, 2007; United States Published Patent Application No. 20090199960 entitled “Pattern Transfer Printing by Kinetic Control of Adhesion to an Elastomeric Stamp” filed Jun. 9, 2006; United States Published Patent Application. No. 20070032089 entitled “Printable Semiconductor Structures and Related Methods of Making and Assembling” filed Jun. 1, 2006; United States Published Patent Application No. 20080108171 entitled “Release Strategies for Making Transferable Semiconductor Structures, Devices and Device Components” filed Sep. 20, 2007; and United States Published Patent Application No. 20080055581 entitled “Devices and Methods for Pattern Generation by Ink Lithography”, filed Feb. 16, 2007.

As used herein term ‘stretchable’ may generally refer to the ability of a material, structure, device or device component to be strained without undergoing fracture. With reference to the present invention, the term “stretchable”, and roots and derivations thereof, when used to modify circuitry or components thereof is meant to encompass circuitry that comprises components having soft or elastic properties capable of being made longer or wider without tearing or breaking, and it is also meant to encompass circuitry having components (whether or not the components themselves are individually stretchable as stated above) that are configured in such a way so as to accommodate and remain functional when applied to a stretchable, inflatable, or otherwise expandable surface. The term “expandable”, and roots and derivations thereof, when used to modify circuitry or components thereof is also meant to have the meaning ascribed above. Thus, “stretch” and “expand”, and all derivations thereof, may be used interchangeably when referring to the present invention. In embodiments, at the low end of ‘stretchable’, this may translate into material stains greater than 0.5% without fracturing, and at the high end to structures that may stretch 100,000% without a degradation of electrical performance. The terms ‘flexible’ and ‘bendable’ are used synonymously, and refer to the ability of a material, structure, device or device component to be deformed into a curved or nonplanar shape without undergoing a transformation that introduces significant strain, such as strain characterizing the failure point. “Electronic device” is used broadly herein to refer to devices such as integrated circuits, imagers or other optoelectronic devices. “Electronic device” also may refer to a component of an electronic device such as passive or active components such as a semiconductor, interconnect, contact pad, transistors, diodes, LEDs, circuits, etc. In the present invention electronic devices may be made, among other ways, using single crystal silicon. “Device component” broadly refers to an individual component within an electrical device. A component can be one or more of a photodiode, LED, TFT, electrode, semiconductor, other light-collecting/detecting components, transistor, integrated circuit, contact pad capable of receiving a device component, thin film devices, circuit elements, control elements, microprocessors, transducers, sensors and the like, and combinations thereof. A device component may be connected to one or more contact pads as known in the art, such as metal evaporation, wire bonding, application of solids or conductive pastes, and the like. “Ultrathin” refers to devices of thin geometries that exhibit bendability.

In some embodiments of the invention, semiconductors are printed onto flexible plastic substrates, creating bendable macro-electronic, micro-electronic, and/or nano-electronic devices. Note that the term ‘plastic’ may refer to any synthetic or naturally occurring material or combination of materials that can be molded or shaped, generally when heated, and hardened into a desired shape. The term ‘elastomer’ may refer to a polymeric material which can be stretched or deformed and return to its original shape without substantial permanent deformation. Elastomers may withstand substantial elastic deformations. These bendable thin film electronics devices on plastic may exhibit field effect performance similar to or exceeding that of thin film electronics devices fabricated by conventional high temperature processing methods. In addition, these flexible semiconductor on plastic structures may provide bendable electronic devices compatible with efficient high throughput processing on large areas of flexible substrates at lower temperatures, such as room temperature processing on plastic substrates. This technology may provide dry transfer contact printing techniques that are capable of assembling bendable thin film electronics devices by depositing a range of high quality semiconductors, including single crystal Si ribbons, GaAs, INP wires, and carbon nano-tubes onto plastic substrates. This high performance printed circuitry on flexible substrates enables an electronics structure that has wide ranging applications. The '367 patent and associated disclosure illustrates an example set of steps for fabricating a bendable thin film electronics device in this manner. (See FIG. 26A of the '367 patent for Example)

In addition to being able to fabricate semiconductor structures on plastic, it has been demonstrated that metal-semiconductor electronics devices may be formed with printable wire arrays, such as GaAs micro-wires, on the plastic substrate. Similarly, other high quality semiconductor materials have been shown to transfer onto plastic substrates, including Si nano-wires, micro-ribbons, platelets, and the like. In addition, transfer printing techniques using elastomeric stamps may be employed. The '367 patent provides an example illustration of the major steps for fabricating, on flexible plastic substrates, electronics devices that use arrays of single wires (in this instance GaAs wires) with expitaxial channel layers, and integrated ohmic contacts. (See FIG. 41 of the '367 patent). In an example, a semi-insulating GaAs wafer may provide the source material for generating the micro-wires. Each wire may have multiple ohmic stripes separated by a gap that defines the channel length of the resultant electronic device. Contacting a flat, elastomeric stamp of PDMS to the wires forms a van der Waals bond. This interaction enables removal of all the wires from the wafer to the surface of the PDMS when the stamp is peeled back. The PDMS stamp with the wires is then placed against an uncured plastic sheet. After curing, peeling off the PDMS stamp leaves the wires with exposed ohmic stripes embedded on the surface of the plastic substrate. Further processing on the plastic substrate may define electrodes that connect the ohmic stripes to form the source, drain, and gate electrodes of the electronics devices. The resultant arrays are mechanically flexible due to the bendability of the plastic substrate and the wires.

Mechanical flexibility may represent an important characteristic of devices on plastic substrates for many applications. Micro/nano-wires with integrated ohmic contacts provide a unique type of material for high performance devices that can be built directly on a wide range of device substrates. Alternatively, other materials may be used to connect electrical components together, such as connecting electrically and/or mechanically by thin polymer bridges with or without metal interconnects lines.

In embodiments, an encapsulation layer may be utilized. An encapsulating layer may refer to coating of the device, or a portion of the device. In embodiments, the encapsulation layer may have a modulus that is inhomogeneous that spatially varies. Encapsulation layers may provide mechanical protection, device isolation, and the like. These layers may have a significant benefit to stretchable electronics. For example, low modulus PDMS structures may increase the range of stretchability significantly (described at length in the ‘811 application). The encapsulation layer may also be used as a passivation later on top of devices for the protection or electrical isolation. In embodiments, the use of low modulus strain isolation layers may allow integration of high performance electronics. The devices may have an encapsulation layer to provide mechanical protection and protection against the environment. The use of encapsulation layers may have a significant impact at high strain. Encapsulants with low moduli may provide the greatest flexibility and therefore the greatest levels of stretchability. As referred to in the '811 application, low modulus formulations of PDMS may increase the range of stretchability from 60%. Encapsulation layers may also relieve strains and stresses on the electronic device, such as on a functional layer of the device that is vulnerable to strain induced failure. In embodiments, a layering of materials with different moduli may be used. In embodiments, these layers may be a polymer, an elastomer, and the like.

Returning to flexible and stretchable electronics technologies that may be utilized in the present invention, it has been shown that buckled and wavy ribbons of semiconductor, such as GaAs or Silicon, may be fabricated as part of electronics on elastomeric substrates. Semiconductor ribbons, such as with thicknesses in the submicron range and well-defined, ‘wavy’ and/or ‘buckled’ geometries have been demonstrated. The resulting structures, on the surface of, or embedded in, the elastomeric substrate, have been shown to exhibit reversible stretchability and compressibility to strains greater than 10%. By integrating ohmic contacts on these structured GaAs ribbons, high-performance stretchable electronic devices may be achieved. The '292 patent illustrates steps for fabricating stretchable GaAs ribbons on an elastomeric substrate made of PDMS, where the ribbons are generated from a high-quality bulk wafer of GaAs with multiple epitaxial layers (See FIG. 22). The wafer with released GaAs ribbons is contacted to the surface of a pre-stretched PDMS, with the ribbons aligned along the direction of stretching. Peeling the PDMS from the mother wafer transfers all the ribbons to the surface of the PDMS. Relaxing the prestrain in the PDMS leads to the formation of large scale buckles/wavy structures along the ribbons. The geometry of the ribbons may depend on the prestrain applied to the stamp, the interaction between the PDMS and ribbons, and the flexural rigidity of the ribbons, and the like. In embodiments, buckles and waves may be included in a single ribbon along its length, due for example, to thickness variations associated with device structures. In practical applications, it might be useful to encapsulate the ribbons and devices in a way that maintains their stretchability. The semiconductor ribbons on an elastomeric substrate may be used to fabricate high-performance electronic devices, buckled and wavy ribbons of semiconductor multilayer stacks and devices exhibiting significant compressibility/stretchability. In embodiments, the present invention may utilize a fabrication process for producing an array of devices utilizing semiconductor ribbons, such as an array of CMOS inverters with stretchable, wavy interconnects. Also, a strategy of top layer encapsulation may be used to isolate circuitry from strain, thereby avoiding cracking

In embodiments, a neutral mechanical plane (NMP) in a multilayer stack may define the position where the strains are zero. For instance, the different layers may include a support layer, a functional layer, a neutral mechanical surface adjusting layer, an encapsulation layer with a resultant neutral mechanical surface such as coincident with the functional layer, and the like. In embodiments, the functional layer may include flexible or elastic device regions and rigid island regions. In embodiments, an NMP may be realized in any application of the stretchable electronics as utilized in the present invention.

In embodiments, semiconductor ribbons (also, micro-ribbons, nano-ribbons, and the like) may be used to implement integrated circuitry, electrical interconnectivity between electrical/electronic components, and even for mechanical support as a part of an electrical/electronic system. As such, semiconductor ribbons may be utilized in a great variety of ways in the configuration/fabrication of flexible and stretchable electronics, such as being used for the electronics or interconnection portion of an assembly leading to a flexible and/or stretchable electronics, as an interconnected array of ribbons forming a flexible and/or stretchable electronics on a flexible substrate, and the like. For example, nano-ribbons may be used to form a flexible array of electronics on a plastic substrate. The array may represent an array of electrode-electronics cells, where the nano-ribbons are pre-fabricated, and then laid down and interconnected through metallization and encapsulation layers. Note that the final structure of this configuration may be similar to electronics device arrays as fabricated directly on the plastic, as described herein, but with the higher electronics integration density enabled with the semiconductor ribbons. In addition, this configuration may include encapsulation layers and fabrication steps which may isolate the structure from a wet environment. This example is not meant to limit the use of semiconductor ribbons in any way, as they may be used in a great variety of applications associated with flexibility and stretchability. For example, the cells of this array may be instead connected by wires, bent interconnections, be mounted on an elastomeric substrate, and the like, in order to improve the flexibility and/or stretchability of the circuit.

Wavy semiconductor interconnects is only one form of a broader class of flexible and stretchable interconnects that may be referred to as ‘bent’ interconnects, where the material may be semiconductor, metal, or other conductive material, formed in ribbons, bands, wire, traces, and the like. A bent configuration may refer to a structure having a curved shape resulting from the application of a force, such as having one or more folded regions. These bent interconnections may be formed in a variety of ways, and in embodiments, where the interconnect material is placed on an elastomeric substrate that has been pre-strained, and the bend form created when the strain is released. In embodiments, the pre-strain may be pre-stretched or pre-compressed, provided in one, two, or three axes, provided homogeneously or heterogeneously, and the like. The wavy patterns may be formed along pre-strained wavy patterns, may form as ‘pop-up’ bridges, may be used with other electrical components mounted on the elastomer, or transfer printed to another structure. Alternately, instead of generating a ‘pop-up’ or buckled components via force or strain application to an elastomeric substrate, a stretchable and bendable interconnect may be made by application of a component material to a receiving surface. Bent configurations may be constructed from micro-wires, such as transferred onto a substrate, or by fabricating wavy interconnect patterns either in conjunction with electronics components, such as on an elastomeric substrate.

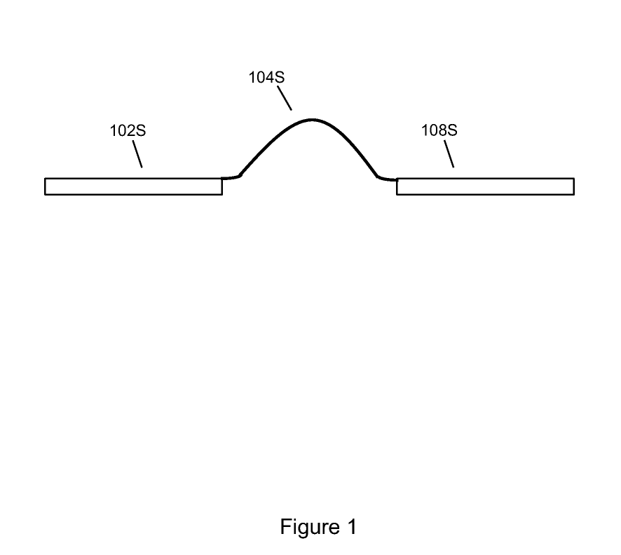

Semiconductor nanoribbons, as described herein, may utilize the method of forming wavy ‘bent’ interconnections through the use of forming the bent interconnection on a pre-strained elastomeric substrate, and this technique may be applied to a plurality of different materials. Another general class of wavy interconnects may utilize controlled buckling of the interconnection material. In this case, a bonding material may be applied in a selected pattern so that there are bonded regions that will remain in physical contact with the substrate (after deformation) and other regions that will not. The pre-strained substrate is removed from the wafer substrate, and upon relaxation of the substrate, the unbounded interconnects buckle (‘pop-up’) in the unbonded (or weakly bonded) regions. Accordingly, buckled interconnects impart stretchability to the structure without breaking electrical contact between components, thereby providing flexibility and/or stretchability. FIG. 1 shows a simplified diagram showing a buckled interconnection 104S between two components 108S.

In embodiments, any, all, or combinations or each of the interconnection schemes described herein may be applied to make an electronics support structure more flexible or bendable, such as applying bent interconnects to a flexible substrate, such as plastic or elastomeric substrates. However, these bent interconnect structures may provide for a substantially more expandable or stretchable configuration in another general class of stretchable electronic structures, where rigid semiconductor islands are mounted on an elastomeric substrate and interconnected with one of the plurality of bent interconnect technologies. This technology is presented here, and also in the '262 application, which has been incorporated by reference in its entirety. This configuration also uses the neutral mechanical plane designs, as described herein, to reduce the strain on rigid components encapsulated within the system. These component devices may be thinned to the thickness corresponding to the desired application or they may be incorporated exactly as they are obtained. Devices may then be interconnected electronically and encapsulated to protect them from the environment and enhance flexibility and stretchability.

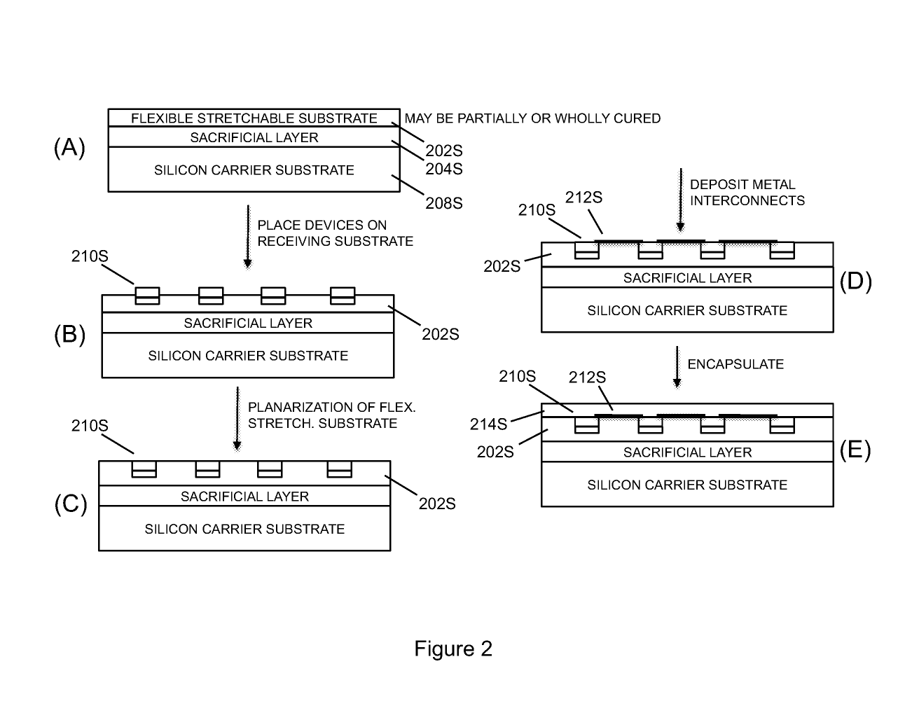

In an embodiment, the first step in a process to create stretchable and flexible electronics as described herein involves obtaining required electronic devices and components and conductive materials for the functional layer. The electronics are then thinned (if necessary) by using a back grinding process. Many processes are available that can reliably take wafers down to 50 microns. Dicing chips via plasma etching before the grinding process allows further reduction in thickness and can deliver chips down to 20 microns in thickness. For thinning, typically a specialized tape is placed over the processed part of the chip. The bottom of the chip is then thinned using both mechanical and/or chemical means. After thinning, the chips may be transferred to a receiving substrate, wherein the receiving substrate may be a flat surface on which stretchable interconnects can be fabricated. FIG. 2 illustrates an example process, which begins by creating a flexible substrate 202S on the carrier 208S coated with a sacrificial layer 204S (FIG. 2A), placing devices 210S on the flexible substrate (FIG. 2B), and performing a planarization step in order to make the top surface of the receiving substrate the same height as that of the die surface (FIG. 2C). The interconnect fabrication process follows. The devices 210S deposited on the receiving substrate are interconnected 212S which join bond pads from one device to another (FIG. 2D). In embodiments, these interconnects 212S may vary from 10 microns to 10 centimeters. A polymeric encapsulating layer 210S may then be used to coat the entire array of interconnected electronic devices and components (FIG. 2E). The interconnected electronic devices are then released from the substrate by etching away sacrificial materials with a solvent. The devices are then ready to undergo stretch processing. They are transferred from the rigid carrier substrate to an elastomeric substrate such as PDMS. Just before the transfer to the new substrate, the arrays are pre-treated such that the device/component islands preferentially adhere to the surface leaving the encapsulated interconnects free to be displaced perpendicular to the receiving substrate.

In embodiments, the interconnect system is a straight metal line connecting two or more bond pads. In this case the electronic array is transferred to a pre-strained elastomeric substrate. Upon relaxation of this substrate the interconnects will be displaced perpendicular to the substrate, thus producing outward buckling. This buckling enables stretching of the system.

In another embodiment, the interconnects are a serpentine pattern of conductive metal. These types of interconnected arrays need not be deposited on a pre-strained elastomeric substrate. The stretchability of the system is enabled by the winding shape of the interconnects.

Stretchable/flexible circuits may be formed on paper, plastic, elastomeric, or other materials with the aid of techniques including but not limited to conventional photolithographic techniques, sputtering, chemical vapor deposition, ink jet printing, or organic material deposition combined with patterning techniques. Semiconductor materials which may be used to make circuits may include amorphous silicon, polycrystalline silicon, single-crystal silicon, conductive oxides, carbon nanotubes and organic materials. In embodiments, the interconnects may be formed of electrically conducting film, stripe, pattern, and the like, such as on an elastomer or plastic material, where the film may be made to buckle, deform, stretch, and the like, as described herein. In embodiments, the interconnect may be made of a plurality of films, such as on or embedded in the flexible and/or a stretchable substrate or plastic.

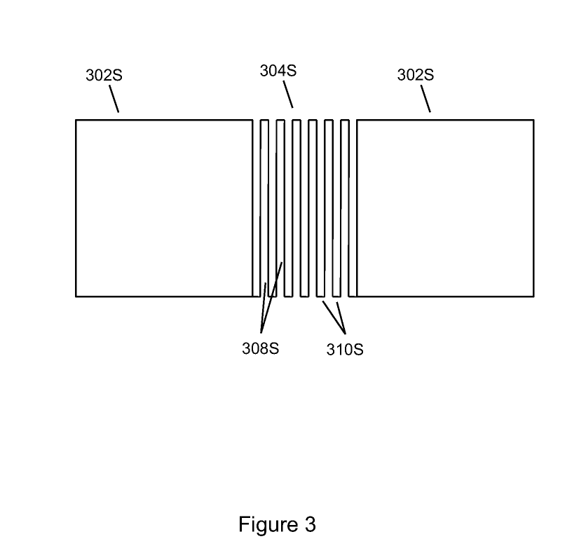

In embodiments, the interconnection of semiconductor islands 302S may utilize an extremely stretchable interconnect 304S, such as shown in FIG. 3, and such as the various configurations disclosed in the '922 application. The novel geometry of the interconnects 304S is what makes them extremely compliant. Each interconnect 304S is patterned and etched so that its structural form has width and thickness dimensions that may be of comparable size (such as their ratio or inverse ratio not exceeding about a factor of 10); and may be preferably equal in size. In embodiments, the interconnect may be formed in a boustrophedonic style such that it effectively comprises long bars 308S and short bars 310S. This unique geometry minimizes the stresses that are produced in the interconnect when subsequently stretched because it has the effective form of a wire, and behaves very differently than interconnect form factors having one dimension greatly exceeding the other two (for example plates). Plate type structures primarily relieve stress only about a single axis via buckling, and withstand only a slight amount of shear stress before cracking This invention may relieve stress about all three axes, including shears and any other stress. In addition, because the interconnect may be formed out of rigid materials, after being stretched it may have a restorative force which helps prevent its wire-like form from getting tangled or knotted when re-compressing to the unstretched state. Another advantage of the boustrophedonic geometry is that it minimizes the initial separation distance between the islands. In embodiments, the interconnects may be formed either monolithically (i.e., out of the same semiconductor material as the device islands) or may be formed out of another material.

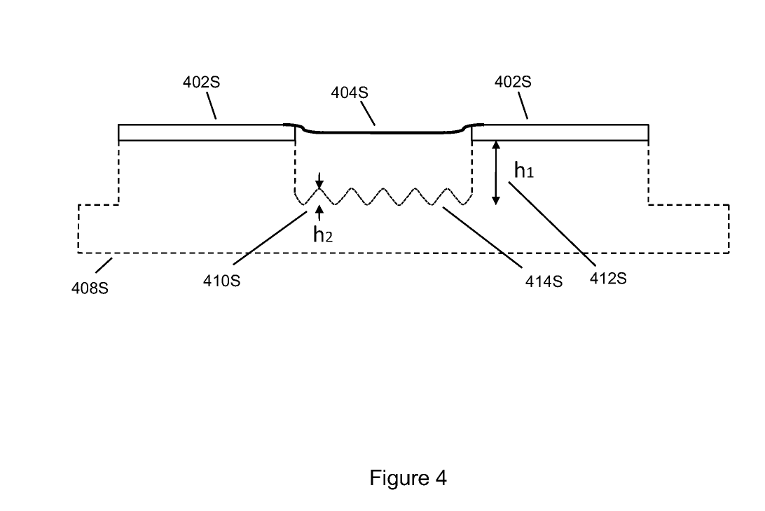

In another embodiment the elastomeric substrate may comprise two layers separated by a height 412S, such as shown in FIG. 4. The top “contact” layer contacts the device island 402S, where the device islands 402S are interconnected 404S with one of the interconnection schemes described herein. In addition, the bottom layer may be a “wavy” layer containing ripples 414S or square waves molded into the substrate 408S during elastomer fabrication. These waves enable additional stretching, whose extent may depend on the amplitude 410S and wavelength of the waves pattern-molded in the elastomer.

In embodiments, the device island may be any prefabricated integrated circuit (IC), where the IC may be mounted on, inside, between, and the like, a flexible and/or stretchable substrate. For example, an additional elastomeric layer may be added above the structure as shown in FIG. 4, such as to encapsulate the structure for protection, increased strength, increase flexibility, and the like. Electrical contacts to embedded electrical components may be provided across the embedded layer, through the elastomeric layer(s) from a second electrical interconnection layer, and the like. For example, an IC may be encapsulated in a flexible material where the interconnects are made accessible as described in the '849 application. (Se FIG. 1 of the '849 application for example). In this example the embedded IC is fabricated by first placing the IC onto a carrier, such as a rigid carrier, and where the IC may be a thinned IC (either thinned before the mounting on the carrier, or thinned while on the carrier). A second step may involve a coating of the IC with some adhesive, elastomer, or other insulating material that can be flowed onto the IC. A third step may be to gain access to the electrical contacts of the IC, such as by laser drilling or other method known to the art. A forth step may be to flow electrical conductor into the openings, thus establishing a electrical access to the electrical connections of the IC. Finally, the IC thus encased may be freed from the carrier. Now the structure may be more easily embedded into a flexible substrate while maintaining electrical connectivity. In embodiments, this structure may be a flexible structure, due to the thinness of the IC, the elastic character of the surrounding structure, the elastic configuration of the extended electrical contacts, and the like.

It should be noted that many of the stretchable electronics techniques utilize the process of transfer printing, for example, with a PDMS stamp. In embodiments, the present invention may include a method of dynamically controlling the surface adhesion of a transfer printing stamp, such as described here, and disclosed in the '904 application. Transfer printing stamps have many uses, one of which is to pick up thin films of materials (“targets”) from one surface (“initial surface”) and deposit them onto another surface (“final surface”). The pickup may be achieved by pressing the transfer printing stamp into contact with the targets, applying some pressure to create Van der Waals bonds between the stamp and the targets, peeling off the stamp with the targets, and then placing the stamp with targets into contact with another surface, applying pressure, and peeling off the stamp without the targets so they remain on the final surface. If the final surface has a higher bonding strength with the targets than the transfer stamp, they will remain on the final surface when the transfer stamp is peeled off. Alternately, the rate of peeling the transfer stamp can be adjusted to vary the target to stamp and target to final surface bonding force ratio. The present invention describes a novel method of depositing the targets, by changing the surface adhesion of the transfer stamp after the targets have been picked up. This may be done while the stamp with targets is in contact with the final surface. In embodiments, the adhesion control can be done by introducing micro-fluidic channels into the transfer stamp, so that water or other fluid can be pumped to the surface of the stamp from within it, thereby changing the surface adhesion from sticky to non-sticky.

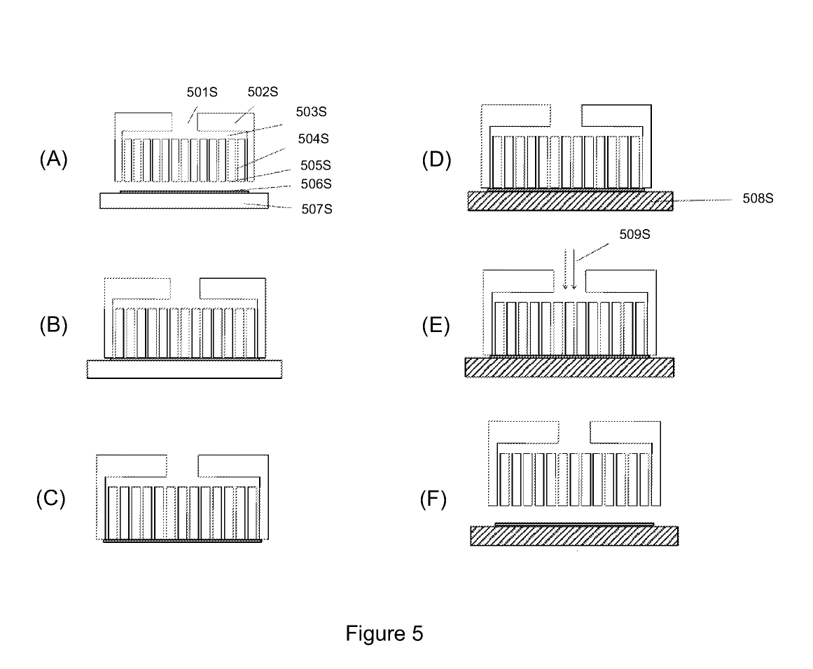

In embodiments, the present invention may accomplishes transfer printing by using a transfer printing stamp that has been formed with micro-fluidic channels such that a fluid (liquid or gas) can be pumped to the surface of the stamp to wet or chemically functionalize the surface and therefore change the surface adhesion of the stamp surface. The transfer printing stamp may be made out of any material, including but not limited to poly-dimethyl-siloxane (PDMS) and derivatives thereof. In one non-limiting embodiment, the stamp is a piece of PDMS formed into a cuboid, which may have dimensions ranging from about 1 micrometer to 1 meter. For this example, the cuboid is 1 cm×1 cm×0.5 cm (length, width, thickness). One 1 cm×1 cm surface of the cuboid is designated as the stamping face. By using a photolithography mask, or a stencil mask, a pattern of vertical holes (channels) is etched from the stamping face through to the opposing face of the stamp. This may be done with an oxygen reactive ion etch. These holes are the micro-fluidic channels, and may be about 0.1-10 micrometers in diameter. They may be spaced apart by about 1-50 micrometers. Another piece of PDMS may be formed into a reservoir shape (eg. a 1 cm×1 cm×0.5 cm cuboid with a smaller cuboid (about 0.8 cm×0.8 cm×0.3 cm) cut out from one surface). This shape may be formed by pouring the PDMS into a mold, curing it, and removing it from the mold. This additional piece of PDMS may then be placed into contact with the first piece of PDMS and bonded (this may be done via ultraviolet ozone exposure or oxygen plasma exposure of the PDMS prior to contacting the two pieces) such that the two pieces form the shape shown in FIG. 5A. Then, one or more holes may be punctured into the top of the reservoir so that a fluidic pipe can be fitted for pumping water into the stamp. In another non-limiting embodiment, the stamp is constructed as described above, except that the first piece of PDMS is formed to have micro-fluidic channels by means of molding. PDMS molding is a well known art. First, a mold is created that is the inverse of the desired shape. In this case, that is an array of vertical posts on a base with four walls. This mold is then filled with PDMS by pouring in the PDMS, allowing it to cure (which may be at elevated temperature), and then removing the PDMS. In another non-limiting embodiment, the stamping surface is also patterned with an array of shallow-etched surface channels. In embodiments, these channels may be about 100-10000 nm wide, and 100-10000 nm etched-into the PDMS. They may form a linear array or a checkerboard grid. The purpose of the channels is to help distribute a liquid from the vertical micro-fluidic channels around the surface of the stamp. In addition, these channels serve to allow an exit for the air that must be displaced to push the liquid to the surface of the stamp. An example of a liquid that may be used includes, but is not limited to, water (which will wet the surface of the stamp and decrease its adhesivity). In the case of a gas fluid, these surface channels may not be necessary. Examples of gasses that can lower the surface adhesion of PDMS are dimethyldichlorosilane (DDMS), perfluorooctyltrichlorosilane (FOTS), perfluorodecyltris(dimethylamino)silane (PF10TAS), and perfluorodecanoic acid (PFDA), and the like.

In embodiments, the stamp may be operated as shown in FIG. 5. First, it is pressed into contact with a substrate that has the target material or devices to be picked up. (FIG. 5A). The target material is picked up by Van der Waal's forces between itself and the stamp as is well known (FIGS. 5B,C). Target material is placed in contact with the final substrate, and pressed into contact (FIG. 5D). The fluid (for example, water) is pumped to the stamp surface, to reduce adhesion (FIG. 5E). The stamp may be left in this state (of contact with water) for as long as necessary for the water to fully wet the stamp surface. Finally, the stamp is removed, leaving the target material behind on the final substrate (FIG. 5F). In FIG. 5A-F, the following labels are made for clarity: fluid inlet 501S; PDMS stamp 502S; fluid distribution reservoir 503S; micro-fluidic channels to stamp surface 504S; adhesive stamp surface 5055; devices to be picked up and transfer printed 6; initial substrate 507S; final substrate 508S; pump in water 509S so it reaches the end of the micro-fluidic channels to alter the surface adhesion of the transfer stamp and release the devices. Note that any surface channels on the stamp surface are not shown in the Figure, and the Figure is not drawn to scale.

Another example of configurations to enable stretchable circuitry are as described in the '125 application in connection with an extendable interconnect. (See FIG. 3 of the '125 application). The electrical component may be considered as one of a plurality of interconnected nodes, whose interconnections expand/extend as the underlying flexible substrate expands. In embodiments, flexible and stretchable electronics may be implemented in a great variety of ways, including configurations involving the substrate, the electrical components, the electrical interconnects, and the like, and involve electrical, mechanical, and chemical processes in their development and implementation.

The present invention accomplishes the monitoring of vehicle tire and/or road surface conditions through use and integration of flexible and/or stretchable electronics. The techniques, processes, and configurations described above could be used alone or in combination to achieve the desired properties of the stretchable or flexible circuit. While certain techniques, processes, and configurations for making and using stretchable and/or flexible circuitry in a tire are described below, the skilled artisan will appreciate such is not the only way of achieving such result.

In connection with the disclosure below, “Electronic device” is used broadly herein to integrated circuits having a wide range of functionality. The electronic devices may be discrete operative devices. The operative devices can be, or their functionality can include, integrated circuits, sensors (e.g. temperature, pH, light, temperature, chemical, etc), amplifiers, A/D and D/A converters, associated differential amplifiers, buffers, microprocessors, optical collectors, transducer including electro-mechanical transducers, piezo-electric actuators, light emitting electronics which include LEDs, logic, memory, clock, and transistors including active matrix switching transistors, and combinations thereof (such items may also be “device components” as described below). The purpose and advantage of using standard ICs (in embodiments, CMOS, on single crystal silicon) is to have and use high quality, high performance, and high functioning circuit components that are also already commonly mass-produced with well known processes, and which provide a range of functionality and generation of data far superior to that produced by a passive means. For purposes of the invention, passive systems are defined by their absence of local amplification, and/or a lack of the ability to perform (on-board) any the functionality described above and herein.

“Device component” broadly refers to an individual component within an electronic devices or operative devices described above. A component can be one or more of any of the electronic devices described above and/or may include a photodiode, LED, TUFT, electrode, semiconductor, other light-collecting/detecting components, transistor, contact pad capable of contacting a device component, thin-film devices, circuit elements, control elements, microprocessors, interconnects, contact pads, and/or other passive or active components. A device component may be connected to one or more contact pads as known in the art, such as metal evaporation, wire bonding, application of solids or conductive pastes, and the like.

“Ultrathin” refers to devices of thin geometries that exhibit, among other things, bendability.

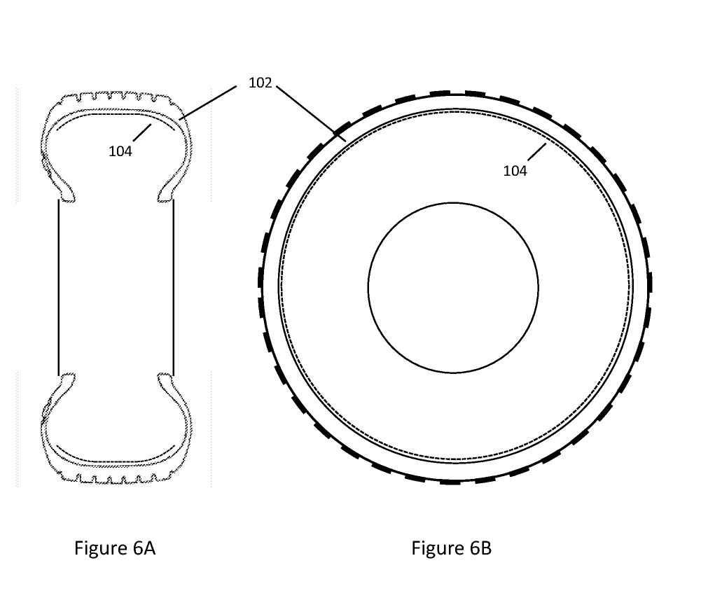

Embodiments of the present invention involve a tire with flexible and/or stretchable electronics (including devices or components thereof) integrated into its structure. The stretchable electronics may be in the form of sensing arrays for measuring material and mechanical properties of the tire and the surface with which it is in contact. In embodiments, electronic devices comprise islands, which house required circuitry and are interconnected mechanically and electronically via interconnects. The interconnects may be strategically designed to preferentially absorb strain and thus channel destructive forces away from the device islands. They may provide the mechanism by which the integrated circuits absorb large strain by flexing and stretching when a force is applied. The device islands and interconnects may be integrated onto a surface of the tire or sandwiched between layers of material of which the tire is constructed. FIGS. 6A and 6B show the stretchable electronics 104, such as comprising the device islands and interconnects, on the inside surface 104 of the tire 102. This can be done by transfer printing, which is described herein. In embodiments, encapsulation of electronic devices and system/device interconnect integration may be the last steps in circuit fabrication.

In embodiments, the circuitry used in the device may comprise one or more of thin film transistors (TFT), electrodes, semiconductors, thin film devices, circuit elements, control elements, microprocessors, transducers, and the like, and combinations thereof. A plurality of device components may include integrated circuits, physical sensors (e.g. temperature), amplifiers, A/D and D/A converters, electro-mechanical transducers, piezo-electric actuators, antennas, and the like, and combinations thereof

In embodiments, the specific fabrication method may depend on the specific circuit classes desired to incorporate into the polymeric substrate. A non-limiting example of the fabrication steps an electronic device in accordance with the present invention is described as follows:

Electrical devices can be laid out in a device island arrangement. The device islands in this example are ˜50 μm×50 μm2 squares, most of which accommodate one or more components (e.g. photo-detector sensor and blocking diode), connected to a buffer and also to an amplifier. Some islands accommodate active matrix switches and A/D converters, and some islands accommodate logic circuitry capable of reading in digital signals and processing them, and are capable of outputting data or storing data in memory cells. Some islands are simply designed and used as metal contact pads. The circuits on these islands are configured and designed such that preferably only about one, but not more than about 100 electrical interconnections are required between any two device islands.

In the present embodiment, the sensors can be fabricated on an SOI wafer (1.2 μm thick top Si, 1 μm thick buried oxide) using standard CMOS fabrication technology, and the silicon space in between each island is etched away to isolate each island. The circuits are protected by a polyimide passivation layer, then a short HF etch step is applied to partially undercut the islands. The passivation layer is removed, and then a thin film of SiO2 is deposited and patterned (100 nm thick) by PECVD or other deposition technique combined with a lift-off procedure, such that the oxide layer covers most of the space between device islands except for a region that is about 5 μm wide. Another polyimide layer is spun on and patterned into the shape of the interconnect wires/bridges. Typically one bridge may extend from the center of one island edge to the center of another island edge. Alternately, two bridges may extend from each corner of the device island to two different device island corners. Other bridge configurations are understood. The interconnect bridges may be about 25 μm wide and may accommodate multiple electrical lines. The polyimide partially fills underneath the device island where it is undercut; this serves to stabilize the island later in the release process and prevent it from floating away. Vias are etched into the PI layer to allow metal wires, patterned in the next step, to contact the circuits and connect one island to another. (This can be repeated to form additional sets of wires located above the first set.) Another PI layer is spun on (covering the wires and everything else). The PI (both layers) is now isolated by etching with a deposited SiO2 hard mask, in O2 RIE. PI located outside device islands and bridges is etched, as well as PI covering areas that are meant to be externally electrically interfaced, and small areas leading to the underlying oxide. Etch holes may be formed if necessary and then transferred through the silicon or metal layers by wet and or dry etching. The underlying buried oxide is etched away using HF etchant to free the devices, which remain attached to the handle substrate due to the first polyimide passivation layer which contacts the handle wafer near the border around the device islands.

If the HF etch is not controllable enough and seeps under the PI isolation layer and thereby attacks the CMOS devices, then prior to the first PI passivation a brief Argon sputtering can be done to remove any native oxide followed by amorphous silicon sputtering followed by the PI passivation and rest of the processing. After rinsing, the devices are left to air dry.

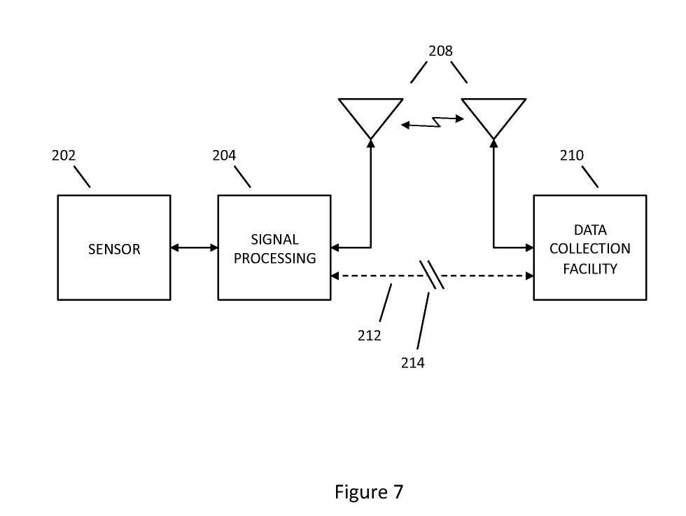

In embodiments, a stretchable circuit sheet may include one or more of the following components: strain sensor (e.g. Wheatstone bridge, piezo-resistive gauges), pressure sensor, contact sensor, temperature sensor (e.g. silicon band gap temperature sensor, resistance temperature device), accelerometer (e.g. piezoelectric, strain gauge) deformation, a set of amplifiers and signal processing units, and a means of transmitting (RF and/or wired) the sensor information to a central processing unit. FIG. 7 illustrates an embodiment block diagram for the present invention, including at least one of a plurality of sensors 202 whose signals are sent for signal processing 204 and communicated to a data collection facility 210. In embodiments, the communications may be through a wireless communications facility 208, wire connected 212, wire connected through a dynamic electrical connection 214 (e.g. slip rings), and the like.

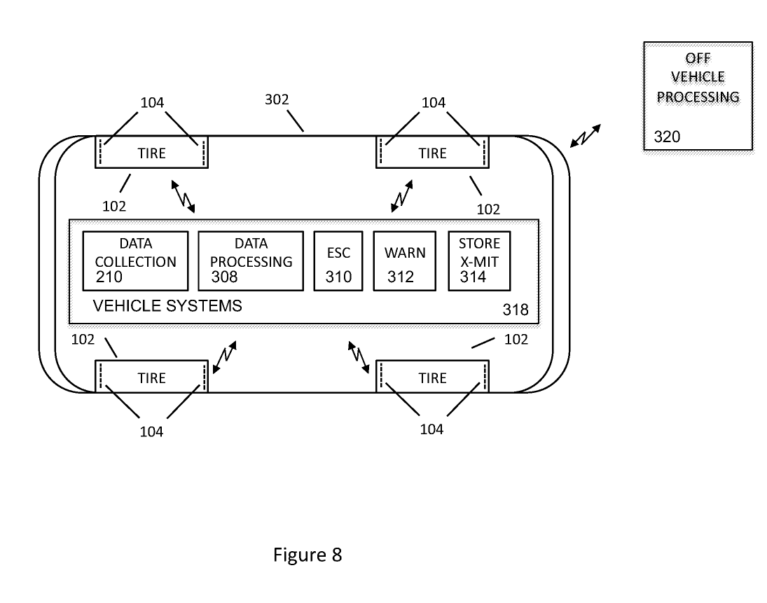

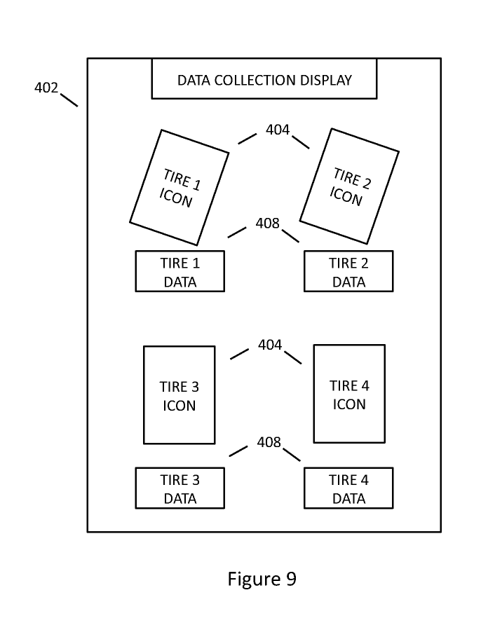

FIG. 8 shows the data collection facility 210 in communication with the stretchable electronics 104 in a plurality of tires 102. In embodiments, the data collection facility 210 may further communicate the sensor data to a vehicle control system, a display system, a recording facility, a transmission facility, and the like. The data collection facility 210 may utilize the information received from the tires 102 to perform one or more functions, such as displaying the tire contact profile. FIG. 9 illustrates an embodiment of a data collection display 402, where, in an example, tire contact profiles may be shown with tire icons 404 and where tire data 408 may be displayed. This information may then be used to make vehicle management control decisions.

Returning to FIG. 8, FIG. 8 illustrates a vehicle 302 and how information gained from the circuits 104 within the tires 102 may be used to control the vehicle 302, produce warnings, produce information, and send information off the vehicle 302 for use by external processing centers. For example, the information that is gathered through sensors associated with the flexible circuits 104 may be used to help control the vehicle 302. The sensor information may be converted into data that is transmitted to a data collection facility 210 (e.g. as described in connection with FIG. 7). The data may then be processed in the data processing facility 308 and/or sent directly to the electronic stability control facility 310. In either case, the data may be used in determining the present state of the vehicle and how to control an aspect of the vehicle. The electronic stability control facility 310 may monitor tire speed, tire slippage, vehicle speed, vehicle acceleration, vehicle spin, vehicle direction, road conditions, weather conditions, steering direction and other such parameters to evaluate the present state of the vehicle's control in an effort to further control the vehicle. In addition, the electronic stability control facility 310 may include an assessment of the information gathered by the in-tire circuits 104. The in-tire circuits may indicate each tire condition and these conditions may be used in the assessment of the present condition of the vehicle and/or in the control of the vehicle. For example, the in-tire circuits may sense tire pressure, temperature, material type, tire type, tread life, tread contact with the road surface, or other parameters (e.g. as described herein) and any of these indicators may be used in the electronic stability control facility 310 in the assessment of the current state of the vehicle and/or in the control of the vehicle.

The information gathered from the in-tire circuits 104 may also be fed to a vehicle warning/information facility 312 in the vehicle. For example, the in-tire circuits 104 may transmit data (e.g. as described in connection with FIG. 7) to the data collection facility 210 and then the data may be communicated to the data processing facility 308 and/or the warning/information system. The warning/information system may provide in-vehicle warnings regarding the tires or provide information regarding the tires. For example, if the tires are not properly contacting the road surface, a warning may be provided and/or information may be stored or displayed for later referral. A warning may be presented on the dash board information display, for example. The information may also be stored such that a mechanic can retrieve the information in a servicing situation. The mechanic may be able to retrieve information that pertains to the present condition of each tire and/or he may be able to retrieve trends and/or alerts based on prior performance. For example, if the tire was run through a pothole and thus suffered a massive and sudden impact, this may be recorded and later presented to the mechanic as an indication and the tire may have suffered harm. The in-tire circuits may have also monitored tread contact, or other parameters, over time and a mechanics report may indicate a trend. The trend may indicate that tire wear may be uneven, for example.

Further referring to FIG. 8, the data collected by the in-tire circuits 104 may be communicated to a system off of the vehicle. The data may be transmitted from the vehicle in any number of ways, such as wirelessly or through a wired connection. The vehicle may transmit the data using a WiFi connection, a cellular network connection (e.g. 3G), a satellite connection or other wireless connection. The data may be received by an off-vehicle processing center 320. The off-vehicle processing center 320 may be operated by an auto dealer, auto mechanic, tire manufacturer, tire installer, tire maintenance shop, or other entity. The off-vehicle processing center 320 may also communicate information to the vehicle. In the situation where the information is sent from the vehicle to the center 320 the center may do further data processing on the data received or the data may be for reference. For example, the data may be compared to data collected from other vehicles to make comparisons on tire performance. The data may also be compared to established trends for a prediction of future tire performance. Such a trend comparison may indicate that a warning or other form of information should be presented back to the vehicle owner or the vehicle itself. In an embodiment, tire temperatures may be monitored and the off-vehicle processing center may make a suggestion that the tires should be changed based on the temperatures. The vehicle may have warm-climate tires and be operating in a cold climate so the recommendation may be to change the tires to obtain better fraction or other performance parameter. This may require an understanding of what type of tire is currently on the vehicle and that may be the type of information that is stored on or with the in-tire circuit 104.

The off-vehicle processing center 320 may make calculations based on data received from the in-tire circuits 104. For example, the data retrieved may be further processed to determine trends, maximum, minimums, or perform other statistical evaluations on the data. The data may also be used to characterize or estimate if the tires have received a high impact, high stress, or out-of-specification conditions. Any of these situations, or other situations, may cause the off vehicle processing center to transmit information back to the vehicle or to the vehicle owner (e.g. through a cell phone or network appliance) as a warning, recommendation, or for informational purposes.

In accordance with one or more embodiments of the invention, the circuitry in the tire may comprise pressure sensor arrays instrumented within its surface or inner layers. Such sensor arrays may be silicon-based and utilize piezo-resistive or capacitive sensing, or may be polymer based, or optically based. The pressure sensor may comprise a flexible and suspended diaphragm of some flexible material such as thin single crystal silicon, polycrystalline silicon, and/or silicon nitride thin film. The diaphragm can be suspended directly above a base layer of doped silicon consisting of a metal electrode layer extracted from an SOI wafer. The polycrystalline silicon diaphragm layer may be formed as a suspended layer by first depositing an SiO2 layer on the silicon electrode. The polycrystalline silicon may then be deposited on the SiO2 layer, which in turn can be selectively etched. This etching step allows for the formation of a suspended and flexible polycrystalline silicon structure. In order to produce diaphragms with a controlled thickness, precise etch rates using HF must be used. This diaphragm with known thickness (2-10 μm thick), material modulus, and surface area and the underlying silicon electrode collectively form a parallel-plate capacitor. The sensor capacitance is a function of distance between the top polycrystalline silicon layer and the underlying silicon electrode. The capacitance recordings can relate diaphragm deflection to changes in capacitance.

In accordance with one or more embodiments of the invention, the circuitry in the tire may have an array of contact sensors incorporated into its surface or inner layers. The contact sensors may be designed to provide an on/off electrical resistance change in response to a pressure, such that when the applied pressure exceeds a predetermined threshold, the sensor provides an electrical signal. One example of how to form a contact sensor is to make a simple mechanical-electrical switch, in which one conductor is mechanically pressed onto another conductor. The lower conductor, located on a surface of the tire, consists of a metal wire that is non-continuous in one or more places to form an open circuit. Encapsulated around this open circuit is a diaphragm formed out of PDMS. The PDMS may be molded or etched into a diaphragm shape. The upper wall of the diaphragm is coated with a metal conductor, by standard means of photolithography patterning, electrochemical etching, etching, shadow evaporation, etc. The diaphragm is aligned and bonded to the relevant surface of the tire. The diaphragm is designed so that when a certain pressure is applied, it bends down to allow the upper conductor to contact and short-circuit the lower non-continuous conductor. This is done by control of the geometry (height and width) and materials of the diaphragm. In another non-limiting example, the diaphragm may be made with MEMS techniques, such as sacrificial silicon dioxide layers with a polycrystalline silicon bridge on top.

To measure relative pressure, each pressure sensor may be coupled with a reference sensor unit, which may have identical electrical characteristics except for a significantly lower pressure sensitivity. Difference pressure measurements between the sensor and the reference unit enable compensation for many parasitic effects. The reference units may be created by leaving a passivation layer on the top surface of the polycrystalline silicon electrode. Having a reference unit along with a pressure sensor unit allows for differential pressure recordings.

In accordance with one or more embodiments of the invention, the circuitry in the tire may have an array of temperature sensors incorporated into the tire's surface or inner layers. The temperature sensors may be, for example, silicon band gap temperature sensor, consisting of silicon diodes. The forward voltage of these silicon diodes are sensitive to changes in temperature. Alternatively, platinum thin-film resistance temperature devices (RTD), which measure temperature based on temperature-induced changes in electrical resistance or thermocouple circuits that sense temperature changes between different thermoelectric materials can be utilized. For thermal resistors, the normalized changes in resistance (R), temperature coefficients of resistors (α), are related to the change in temperature (T) by

ΔR/R=αT.

Platinum (500 Å) and an adhesion layer of chromium (150 Å) can be patterned and deposited on SOI wafers using thermal evaporation via e-beam to define individual RTD sensors. The RTD sensors can be integrated with CMOS based amplifiers, transducers, computation logic elements, and A/D circuitry on the same device islands as previously described.

In another embodiment, the contact stresses on the tires may be determined as follows:

A set of strain and pressure sensors can be fitted on a grid covering the inside surface of the tire. As many forces act on the tire and various portions of the tire contact an uneven road surface, deformation of certain silicon strain sensors and pressure sensors occurs at various points on the grid. The deformation causes changes in electrical properties which are amplified by distributed amplifiers, converted to digital values and transmitted to the processing unit, where the spatial coordinates of the sensors affected and the magnitude and rate of change of signals is used to determine what is happening to the tire and the tire-surface interface. The processing unit can accept inputs from more than one tire and other sources (such as data from accelerometers, braking or throttle commands from the operator, yaw, pitch, etc.) and combine one or more of them to create a more accurate estimate of vehicle state, road conditions, braking effectiveness, tire stresses, tire state, fuel efficiency, or other factors of interest in operation and/or design of the vehicle. It should be evident to one skilled in the art that there are a variety of known sensor types and specific implementations that could be utilized in the manner described above and yield information of interest, such as real-time temperature maps of the tire, local tears of the tire material or just-in-time sensing of distance between tire and rim.

It should be further evident to one skilled in the art that the invention can be applied to pneumatic tires, tube or tubeless tires, solid tires, tires filled with air, fluids or gases, across a wide range of sizes and usage conditions. The tires may be manufactured from a variety of natural or artificial rubber materials or plastics. Travelling surfaces could be roads, factory floors, landing runways, dwellings, off-road terrain, sports tracks, and the like.

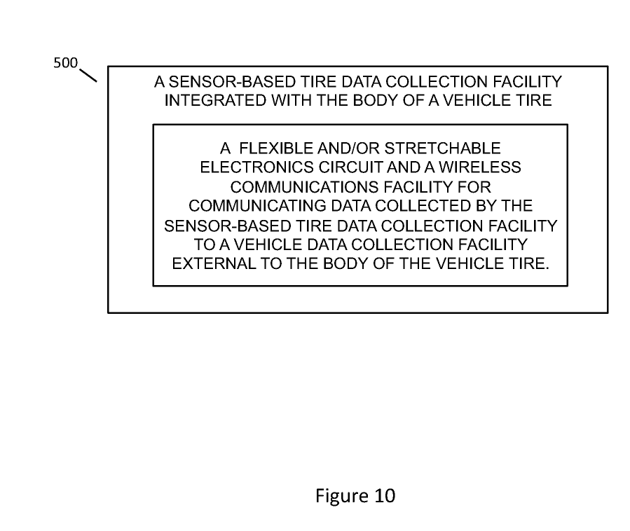

As shown in FIG. 10, the present invention may be a device 500, including a sensor-based tire data collection facility integrated with the body of a vehicle tire, where the sensor-based tire data collection facility may include a flexible and/or stretchable electronics circuit and a wireless communications facility for communicating data collected by the sensor-based tire data collection facility to a vehicle data collection facility external to the body of the vehicle tire. In embodiments, the sensor-based tire data collection facility may collect data in part for monitoring a road feature, or road characteristic, such as friction, temperature, and the like. The data may be in part for monitoring a tire feature, such as strain and/or shearing force in the tire, tire pressure, and the like. The data may in part be for monitoring areas of contact between the tire and a road surface. The data may be recorded, displayed on a user display interface (e.g. displaying the contact area of the tire). The data may be transferred to a vehicle control system for the vehicle, such as to use the data to optimize vehicle performance, improve vehicle safety, and the like. The data may be used to improve the design of a suspension system for the vehicle, improve the design of a drive-train system for the vehicle, improve the design of the tire, and the like. In embodiments, the vehicle may be an airplane, such as to improve the design of the airplane landing gear, to monitor landing gear stress, to monitor braking performance, and the like. The vehicle may be an automobile, bicycle, motorcycle, and the like.

In embodiments, the stretchable electronics may include stretchable interconnects (such as the ones described herein), to absorb strain when they deform without substantial degradation in electrical performance, and the like.

The stretchable electronic circuit may be printable (in embodiments, utilizing techniques as described herein).

As described above, the stretchable electronics may include at least one of a plurality of discrete operative devices, such as with a single crystalline semiconductor structure. As described herein, the discrete operative device may be a sensor, such as a strain sensor, a contact sensor, a pressure sensor, a temperature sensor, an accelerometer, for detecting mechanical properties of the tire, detecting mechanical properties of the road surface. The operative device may continuously generate data, where the data may be recorded. In embodiments, the wireless communication device may be partially stretchable or wholly stretchable, such as including portions that are stretchable and portions that are not stretchable.

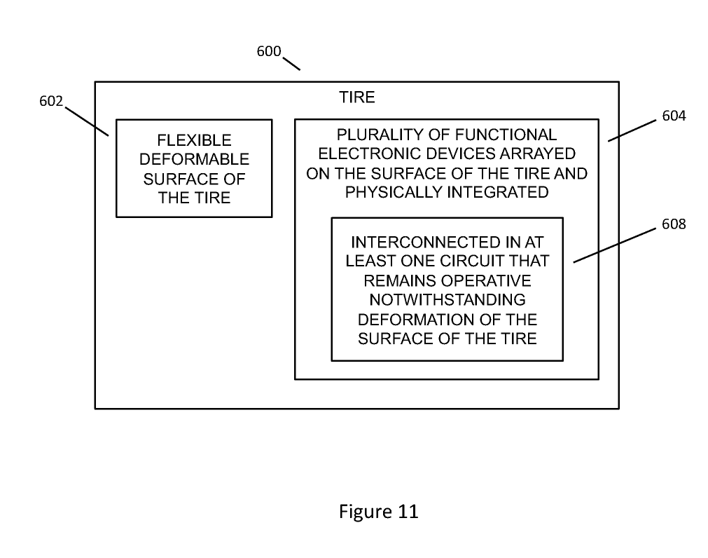

As shown in FIG. 11, the present invention may be a tire 600, including a flexible deformable surface of the tire 602, a plurality of functional electronic devices arrayed on the surface of the tire and physically integrated with the tire 604. The plurality of functional electronic devices may be interconnected 608 in at least one circuit that remains operative notwithstanding deformation of the surface of the tire. In embodiments, the circuit may line the entirety of the inside surface of the tire, a portion of the inside surface of the tire, an internal surface of the tire, and the like. The devices may include a sensor for measuring the mechanical properties of the tire, such as a strain sensor, a pressure sensor, a temperature sensor, an accelerometer, and the like. The devices may include a plurality of sensors, such as arranged in a grid. The devices may include at least one amplifier, where the output of the amplifier may be converted into a form that can be transmitted as data. The data may be transmitted to a processing unit which performs further processing of the data from the tire, such as combining information from multiple sources to determine a state of a vehicle, and the like. In addition, the devices may include sensors for measuring road surface conditions.

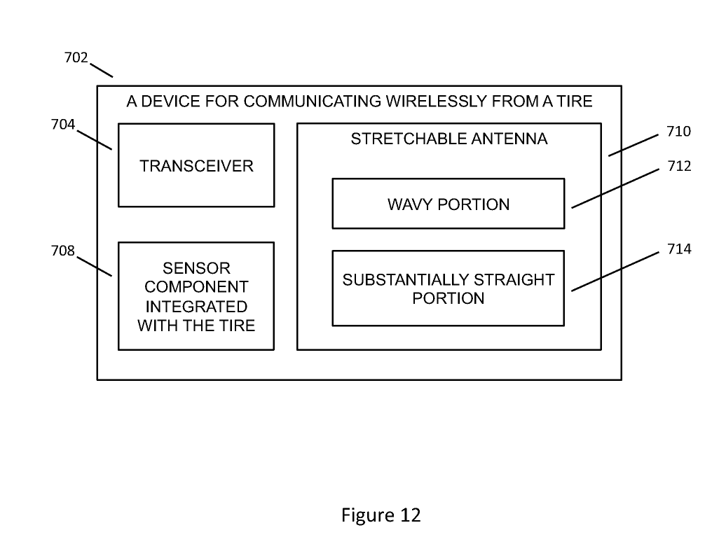

In embodiments, the present invention may wirelessly transmit information from the tire 102 such as illustrated in FIG. 7. In embodiments, the antenna 208 may be a stretchable antenna. For instance, the antenna may be configured in a stretchable configuration such as described herein for stretchable interconnects, in a wavy pattern, in an extremely stretchable configuration, and the like. In embodiments, the stretchable antenna may be wholly stretchable or partially stretchable (e.g. where one aspect of the configuration is stretchable and another is not stretchable). In an example, a portion of the antenna may be made in a wavy stretchable form, and be connected to another portion of the antenna that is not wavy. In embodiments, the present invention may be used to produce flexible and/or stretchable antenna configurations similar to that of flexible and/or stretchable interconnects. As shown in FIG. 12, the present invention may be a device for communicating wirelessly 702 from a tire, including a transceiver 704, a sensor component integrated with the tire 708, and a stretchable antenna 710. The stretchable antenna may include a wavy pattern 712 of metal electrodes electrically connected to a substantially straight portion 714 of metal, and where the device electrically connects the sensor component, transceiver, and stretchable antenna. In embodiments, the transceiver may be an RF transceiver, an RFID transceiver, and the like. The wireless communication device may be partially stretchable, wholly stretchable, and the like, where different portions of the device are stretchable and other portions that are not. The wavy pattern may be created utilizing a deposition onto a pre-strained elastomer substrate, created utilizing a shadow mask deposition onto a wavy elastomer surface, and the like. The transceiver, sensor component, and stretchable antenna may be encapsulated. In embodiments, the metal may be copper platinum gold, aluminum, and the like.

Certain of the methods and systems described in connection with the invention described herein (the “Subject Methods and Systems”) may be deployed in part or in whole through a machine that executes computer software, program codes, and/or instructions on a processor integrated with or separate from the electronic circuitry described herein. Said certain methods and systems will be apparent to those skilled in the art, and nothing below is meant to limit that which has already been disclosed but to the contrary is meant to supplement it.

The active stretchable circuitry described herein may be considered the machine necessary to deploy the Subject Methods and System in full or in part, or a separately located machine may deploy the Subject Methods and Systems in whole or in part. Thus, “machine” as referred to herein may be applied to the active circuitry described above, a separate processor, separate interface electronics or combinations thereof

The Subject Methods and Systems invention may be implemented as a method on the machine, as a system or apparatus as part of or in relation to the machine, or as a computer program product embodied in a computer readable medium executing on one or more of the machines. In embodiments, the processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The Subject Methods and Systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

If the Subject Methods and Systems are embodied in a software program, the software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The Subject Methods and Systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions pertaining to the Subject Methods and Systems described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, program codes, and instructions pertaining to the Subject Methods and Systems described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions pertaining to the Subject Methods and Systems may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The Subject Methods and Systems described herein may transform physical and/or or intangible items from one state to another. The methods and systems described herein may also transform data representing physical and/or intangible items from one state to another.

The elements described and depicted herein and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The Subject Methods and Systems, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above in connection with the Subject Systems and Methods and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been described in connection with certain preferred embodiments, other embodiments would be understood by one of ordinary skill in the art and are encompassed herein.

All documents referenced herein are hereby incorporated by reference.

What is claimed is:

1. A device, comprising:
a sensor-based tire data collection facility integrated with the body of a vehicle tire, wherein the sensor-based tire data collection facility includes a stretchable electronics circuit and a wireless communications facility for communicating data collected by the sensor-based tire data collection facility to a vehicle data collection facility external to the body of the vehicle tire.

2. The device of claim 1, wherein the sensor-based tire data collection facility collects data in part for monitoring a road feature.

3. The device of claim 2, wherein the road feature is a characteristic of the road surface.

4. The device of claim 3, wherein the characteristic is friction.

5. The device of claim 3, wherein the characteristic is temperature.

6. The device of claim 1, wherein the data is in part for monitoring a tire feature.

7. The device of claim 6, wherein the tire feature is at least one of a strain and shearing force in the tire.

8. The device of claim 6, wherein the tire feature is tire pressure.

9. The device of claim 1, wherein the data is in part for monitoring areas of contact between the tire and a road surface.

10. The device of claim 1, wherein the data is recorded.

11. The device of claim 1, wherein the data collection facility displays the data on a user display interface.

12. The device of claim 11, wherein the user display interface displays the contact area of the tire.

13. The device of claim 1, further comprising the data being transferred to a vehicle control system for the vehicle.

14. The device of claim 13 wherein the vehicle control system uses the data to optimize vehicle performance.

15. The device of claim 13, wherein the vehicle control system uses the data to improve vehicle safety.

16. The device of claim 1, wherein the data is recorded.

17. The device of claim 1, wherein the data is used to improve the design of a suspension system for the vehicle.

18. The device of claim 1, wherein the data is used to improve the design of a drive-train system for the vehicle.

19. The device of claim 1, wherein the data is used to improve the design of the tire.

20. The device of claim 1, wherein the vehicle is an airplane.

21. The device of claim 1, wherein the data is used to improve the design of an airplane landing gear.

22. The device of claim 1, wherein the data is used to monitor at least one of landing gear stress and braking performance.

23. The device of claim 1, wherein the vehicle is an automobile.

24. The device of claim 1, wherein the vehicle is a bicycle.

25. The device of claim 1, wherein the vehicle is a motorcycle.

26. The device of claim 1, wherein said stretchable electronics include stretchable interconnects.

27. The device of claim 26, wherein the stretchable interconnects absorb strain when they deform without substantial degradation in electrical performance.

28. The device of claim 1, wherein an aspect of said stretchable electronic circuit is printable.

29. The device of claim 1, wherein said stretchable electronics includes at least one discrete operative device.

30. The device of claim 29, wherein said at least one discrete operative device includes a single crystalline semiconductor structure.

31. The device of claim 29, wherein said at least one discrete operative device comprises a sensor.

32. The device of claim 31, wherein said sensor is a strain sensor.

33. The device of claim 31, wherein said sensor is a contact sensor.

34. The device of claim 31, wherein said sensor is a pressure sensor.

35. The device of claim 31, wherein said sensor is a temperature sensor.

36. The device of claim 31, wherein said sensor is an accelerometer.

37. The device of claim 31, wherein said sensor detects mechanical properties of the tire.

38. The device of claim 31, wherein said sensor detects mechanical properties of a road surface.

39. The device of claim 1, wherein at least one operative device comprises a sensor, said operative device continuously generates data.

40. The device of claim 39, wherein said continuously generated data is recorded.

41. The device of claim 1, wherein the wireless communication device is partially stretchable.

42. The device of claim 1, wherein the wireless communication device is wholly stretchable.

43. A device, comprising:
a road tire sensing facility integrated with the body of a tire, wherein the road tire sensing facility includes a flexible electronics circuit and a wireless communications facility for communicating with a control facility of a vehicle.

44. A tire, comprising:
a flexible deformable surface of the tire;
a plurality of functional electronic devices arrayed on the surface of the tire and physically integrated therewith, wherein the plurality of functional electronic devices are interconnected in at least one circuit that remains operative notwithstanding deformation of the surface of the tire.

45. The tire of claim 44, wherein said circuit lines the entirety of the inside surface of the tire.

46. The tire of claim 44, wherein said circuit lines a portion of the inside surface of the tire.

47. The tire of claim 44, wherein said surface of the tire is an internal surface of the tire.

48. The tire of claim 44, wherein said devices include a sensor for measuring the mechanical properties of the tire.

49. The tire of claim 48, wherein the sensor is a strain sensor.

50. The tire of claim 48, wherein the sensor is a pressure sensor.

51. The tire of claim 48, wherein the sensor is a temperature sensor.

52. The tire of claim 48, wherein the sensor is an accelerometer.

53. The tire of claim 44, wherein said devices include a plurality of sensors.

54. The tire of claim 53, wherein the plurality of sensors are arranged in a grid.

55. The tire of claim 44, wherein said devices include at least one amplifier.

56. The tire of claim 55, wherein the output of the amplifier is converted into a form that can be transmitted as data.

57. The tire of claim 56, wherein the data is transmitted to a processing unit which performs further processing of the data from the tire.

58. The tire of claim 57, wherein the processing unit combines information from multiple sources to determine a state of a vehicle.

59. The tire of claim 44, wherein said devices include sensors for measuring road surface conditions.

60. A device for communicating wirelessly from a tire, comprising:
a transceiver;
a sensor component integrated with the tire;
a stretchable antenna, wherein the stretchable antenna comprises a wavy pattern of metal electrodes electrically connected to a substantially straight portion of metal; and
electrically connecting the sensor component, transceiver, and stretchable antenna.

61. The device of claim 60, wherein the transceiver is an RF transceiver.

62. The device of claim 60, wherein the transceiver is an RFID transceiver.

63. The device of claim 60, wherein the wireless communication device is partially stretchable.

64. The device of claim 60, wherein the wireless communication device is wholly stretchable.

65. The device of claim 60, wherein the wavy pattern is created utilizing a deposition onto a pre-strained elastomer substrate.

66. The device of claim 60, wherein the wavy pattern is created utilizing a shadow mask deposition onto a wavy elastomer surface.

67. The device of claim 60, wherein the metal is copper.

68. The device of claim 60, wherein the metal is platinum.

69. The device of claim 60, wherein the metal is gold.

70. The device of claim 60, wherein the metal is aluminum.

71. The device of claim 60, wherein the transceiver, sensor component, and stretchable antenna are encapsulated.
